(19) United States
(12) Patent Application Publication
(10) Pub. No.: US 2006/0047177 A1
(43) Pub. Date: Mar. 2, 2006

(54) Method for in-line stabilization of paint residue

(76) Inventor: Keith Edward Forrester, Meredith, NH (US)

Correspondence Address: Keith E. Forrester, 78 Tracy Way, Meredith, NH, 03253, US

(21) Appl. No.: 11/214,403

(22) Filed: Aug. 29, 2005

Related U.S. Application Data
(60) Provisional application No. 60/605,721, filed on Aug. 31, 2004.

(51) Int. Cl. B09B 3/00

(52) U.S. Cl. 588/256

(57) ABSTRACT

This invention provides a method for stabilization of paint residue subject to acid and water leaching tests or leach conditions by addition of stabilizing agents in slurry or solution form to blast media such that leaching of heavy metals are inhibited to desired levels. The resultant waste after stabilization is deemed suitable for on-site reuse, off-site reuse or disposal as RCRA non-hazardous waste.

### BACKGROUND OF THE INVENTION

Heavy metal bearing paint residue may be deemed “Hazardous Waste” by the United States Environmental Protection Agency (USEPA) pursuant to 40 C.F.R. Part 261 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized heavy metals such as Arsenic (As), Lead (Pb), Cadmium (Cd), Copper (Cu), Zinc (Zn), Selenium (Se) and Chromium (Cr) above levels deemed hazardous by those country, regional or state regulators.

In the United States, any solid waste can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, Mexico, and Canada. Thailand also limits solubility of Cu and Zn, as these are metals of concern to Thailand groundwater. Switzerland and Japan regulate management of solid wastes by measuring heavy metals and salts as tested by a sequential leaching method using carbonated water simulating rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides a method of reducing the solubility of heavy metal bearing paint residue produced during blasting media use. Paint residue is controlled by the invention under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water. Unlike the present invention, prior art has focused on reducing solubility of Pb from paint residues by application of phosphate sources to the painted surface prior to blast media usage (Forrester U.S. Pat. No. 6,515,053 B1), application of a blend of dry phosphates and blast media to the painted surface (Forrester U.S. Pat. No. 6,186,939 B1), and application of phosphates, carbonates, cement, silicates and complexers in-tanks or waste piles after collection of the paint residue (Forrester U.S. Pat. No. 5,846,178, Forrester U.S. Pat. No. 5,722,928 and Forrester U.S. Pat. No. 5,536,899 and cited art from those applications). These previous methods fail to disclose applying paint residue stabilizer as a wet slurry or wet solution to blast media. The value of this method of introduction of stabilizer onto blast media is that this stabilizer method does not present complications of providing additional dry chemical with the blast media and thus additional dusting during stabilizer-blast media application and eliminates dry stabilizer chemical buildup on the newly cleaned structure surface. This method also allows for distribution of the stabilizer in a uniform manner across the blast media surface even at low stabilizer-to-media application rates, such as 1% to 2% by weight of blast residue as found effective for stabilization of lead and other heavy metals.

The preferred and least expensive paint stabilizer for Pb (the most predominant source of regulated paint residues) would be calcium phosphate sources such as superphosphate, single superphosphate, triple superphosphate, dicalcium phosphate, monocalcium phosphate, tricalcium phosphate for substitution of Pb into calcium phosphate apatite mineral(s). Phosphate addition as dry process or wet process phosphoric acid could be used, but may present risk of damage to blasting nozzle equipment, as ferric-phosphate mineral forms by stripping iron from carbon steel surfaces. The most significant advantage with production of lead substituted calcium phosphate minerals in paint residue is that the solubility constant, and hence leachability and bioavailability, are greatly reduced in this true apatite form at Ksp 10E-85, as compared to the simple lead-phosphate minerals forms at Ksp values greater than 10E-16.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a heavy metal bearing paint stabilization method through contact of paint residues with blast media amended with stabilizer in slurry or solution form. The most predominant paint residue heavy metal, Pb, could be stabilized using calcium phosphate agent source(s) including monocalcium phosphate, dicalcium phosphate, tricalcium phosphate, single superphosphate, triple superphosphate, phosphoric acids, phosphates complexed with chlorides, iron and/or aluminum, portland cement, cement kiln dust, lime kiln dust, lime, dolomitic lime, silicates, phosphates, and combinations thereof. The preferred method of Pb bearing paint residue stabilization would be by contact with phosphates which are properly chosen to complement the lead substitution into calcium phosphate apatite(s). Other heavy metals could be stabilized by addition of stabilization agents onto blast media known to reduce solubility such as iron and lime combinations for arsenic, lime or Portland cement for cadmium, ferrous sulfate and lime or Portland cement for chromium.

### DETAILED DESCRIPTION

Environmental regulations throughout the world such as those developed by the USEPA under RCRA and CERCLA require heavy metal bearing waste, contaminated soils and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in soils. Materials such as paint residues, cleanup site wastes such as battery acids and slag wastes from smelters and incinerators are major lead sources.

There exists a demand for improved and less costly control methods of heavy metals from paint residues, that allows for stabilization into stable non-soluble form. The present invention discloses a paint residue stabilization method through contact with stabilizing agents applied to blast media in a slurry or solution form including monocalcium phosphate, dicalcium phosphate, tricalcium phosphate, Portland Cement, iron, ferrous sulfate, ferric sulfate, ferric chloride, chlorides, cement kiln dust, lime kiln dust, lime, dolomitic lime, phosphates, phosphoric acids, superphosphates, single superphosphates, triple superphosphates, phosphates complexed with chlorides, iron and/or aluminum, and combinations thereof.

The stabilizing agents including monocalcium phosphate, dicalcium phosphate, tricalcium phosphate, Portland Cement, iron, ferrous sulfate, ferric sulfate, ferric chloride, chlorides, cement kiln dust, lime kiln dust, lime, dolomitic lime, phosphates, superphosphates, single superphosphates, triple superphosphates, phosphates complexed with chlorides, iron and/or aluminum, and combinations thereof with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof would be selected through laboratory treatability and/or bench scale testing to provide sufficient control of metals solubility and particle transport potential. In certain cases, such as with the use of amber and green phosphoric acid acid, phosphates may embody sulfuric acid, vanadium, iron, aluminum and other complexing agents which could also provide for a single-step formation of complexed heavy metal minerals. The stabilizer and agglomeration agent type, size, dose rate, contact duration, and slurry or solution application means to the blast media would be engineered for each type of paint residue and blast media. It is anticipated that blast media, such as garnet or coal slag, would have varied affinities for absorption and specific retention of solution and slurry, thus yielding variations in dose ratios selected.

Although the exact stabilization formation Pb apatites(s) are undetermined at this time, it is expected that when lead comes into contact with the stabilizing agents in the presence of paint residue and sufficient reaction time and energy, low TCLP/water soluble apatite minerals form such as a Pb substituted hydroxyapatite, through substitution or surface bonding, which is less soluble than the heavy metal element or molecule originally in the material or waste.

Examples of suitable stabilizing agents include, but are not limited to calcium phosphates, Portland cement, cement kiln dust, lime kiln dust, iron, silicates, phosphate fertilizers, phosphate rock, pulverized phosphate rock, calcium orthophosphates, monocalcium phosphate, dicalcium phosphate, tricalcium phosphate, trisodium phosphates, calcium oxide (quicklime), dolomitic quicklime, natural phosphates, phosphoric acids, dry process technical grade phosphoric acid, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of stabilizing agent and slurry or solution solvent used, according to the method of invention, depend on various factors including desired media weight, media solvent retention, solubility reduction potential, desired mineral toxicity, and desired mineral formation relating to toxicological and site environmental control objectives. It has been found that addition of 2% triple superphosphate in 2% water by weight of blast residue black beauty medium grade blended with 100% Pb bearing paint residue was sufficient for initial TCLP Pb stabilization to less than RCRA 5.0 ppm limit. However, the foregoing is not intended to preclude yet higher or lower usage of stabilizing agent(s) or combinations.

The examples below are merely illustrative of this invention and are not intended to limit it thereby in any way.

### EXAMPLE 1

Paint residue containing lead from an elevated water storage tank was combined with various levels of Black Beauty medium grit blast media (REED Minerals) amended with combinations of New Hampshire residential well water and triple superphosphate (TSP), Dicalcium Phosphate (DCP), Tricalcium Phosphate (TCP), Portland Cement Type I/II (PC), wet process phosphoric acid (WPA), phosphoric acid bearing co-product (CP) and subjected to TCLP analyses by EPA method 1311 extraction and EPA Method 200.6 ICP analyses.

TABLE 1

| Stabilizer Weight Add to Media | Media-Paint Ratio | TCLP Pb (ppm) |
|---|---|---|
| Baseline | 50-50 | 39.00 |
| 1% TSP + 1% H2O | 50-50 | 1.76 |
| 2% TSP + 2% H2O | 50-50 | <0.05 (ND) |
| 4% TSP + 4% H2O | 50-50 | ND |
| 4% DCP + 4% H2O | 50-50 | ND |
| 4% TCP + 4% H2O | 50-50 | ND |
| 10% WPA + 0 H2O | 50-50 | ND |
| 10% CP + 0 H2O | 50-50 | ND |
| 10% PC + 10% H2O | 50-50 | 4.7 |

The foregoing results in Example 1 readily established the operability of the present process to stabilize lead thus reducing leachability and bioavailability. Given the effectiveness of the stabilizing agent and media blend in causing lead to stabilize as presented in the Table 1 it is believed that an amount of the stabilization agents equivalent to less than 4% by weight of lead waste should be effective when applied to blast media in a slurry or solution form prior to blast operations

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of heavy metals within paint residue comprising contacting paint residue with at least one stabilizing agent in combination with blast media in an amount effective in reducing the leaching of heavy metal to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of calcium phosphates, Portland cement, cement kiln dust, lime kiln dust, lime, silicates, iron, quicklime; phosphate complexers chlorides, iron and/or aluminum; wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

3. A method of claim 1 wherein the stabilizers are combined with blast media as a slurry or solution.

4. A method of claim 1 where the paint residue is mixed with blasting media.

5. A method of claim 1 wherein reduction of solubility is to a level no more than non-hazardous levels as determined under leach tests required by regulation in countries other than the USA including but not limited to Switzerland, UK, Mexico, Taiwan, Japan, Thailand, China, Canada, Germany.

6. A method of claim 1 where the metals include As, Cd, Cu, Pb, Se, Hg, Se, Cr, Zn, Ti, Ba.

7. A method of claim 1 where the blast media includes garnet, sand, coal slag, steel shot, aluminum oxide, commercially available blast media.
